(19) United States
(12) Patent Application Publication
(10) Pub. No.: US 2025/0021049 A1
(43) Pub. Date: Jan. 16, 2025

(54) ESCAPEMENT DEVICE FOR A TIMEPIECE

(71) Applicant: Rolex SA, Genève (CH)

(72) Inventors: Fabiano COLPO, Lausanne (CH); Olivier KARLEN, Blonay (CH); Mai Xuan TU, Ecublens (CH)

(21) Appl. No.: 18/770,655

(22) Filed: Jul. 12, 2024

(30) Foreign Application Priority Data
Jul. 12, 2023 (EP) 23184968.8

(51) Int. Cl. G04B 15/06; G04B 13/02; G04B 15/14

(52) U.S. Cl. CPC G04B 15/06; G04B 13/027; G04B 15/14

(57) ABSTRACT

Escapement device, comprising:
first escapement mobile element comprising a plurality of first blocking surfaces and a first drive toothing forming a first main drive toothing,
a second escapement mobile element comprising a plurality of second blocking surfaces and a second drive toothing forming a second main drive toothing,
an inertial element,
a blocking mobile element, comprising:
   blocking surface portions, arranged to come into contact with the first escapement mobile element and with the second escapement mobile element,
   an impulse receiver,
   an impulse transmitter,
characterized in that:
the second main drive toothing and the first main drive toothing are engaged together and cooperate with the blocking mobile element in the same plane.

### CROSS-REFERENCE TO RELATED APPLICATIONS

The present application claims priority to European Application No. 23184968.8 filed with the European Patent Office on Jul. 12, 2023 and entitled “ESCAPEMENT DEVICE FOR A TIMEPIECE,” which is incorporated herein by reference in its entirety for all purposes.

### TECHNICAL FIELD OF THE INVENTION

The present invention generally concerns the escapement devices for timepieces equipped with an inertial element, for example a balance, and particularly, the present invention concerns the tangential drive escapement device with two active vibrations.

### STATE OF THE ART

In the prior art of the escapement devices with two active vibrations, it is known for example from document WO2013182243A1 to provide for a tangential drive escapement device with two active vibrations comprising a single escapement mobile element and two blocking mobile elements cooperating with each other and with the escapement mobile element. In return, in order to be able to occupy a space comparable to the space occupied by a conventional escapement, for example with a Swiss anchor, this system requires small components which are complex to manufacture and assemble.

Document EP1367462A1 is also known which concerns a double indirect-impulse escapement device with a blocker arranged between two escapement wheels. In this document, the blocker has a particularly limited format compared to the respective format of the escapement wheels which are each equipped with a significant number of teeth. The result is that the blocker has a very small size so that its manufacture is complex, or so that the escapement wheels have a large size, which is detrimental to the compactness of the system. Finally, the orientation of the contact force between a given tooth of either of the two escapement wheels and a first or a second blocking means of the blocker is such that restriction pins or detent pins are necessary, in particular in case of shock.

Document CH712631A1 relates to an escapement device comprising two escapement wheels, as well as a lever interacting these two escapement wheels with an oscillator.

### DISCLOSURE OF THE INVENTION

One aim of the present invention is to overcome the drawbacks of the prior art mentioned above and particularly, first of all, to propose a tangential drive escapement device with two active vibrations whose components are easier to manufacture and/or assemble, and/or whose bulk is reduced, and/or which has a robust operation.

For this, a first aspect of the invention can relate to an escapement device for a timepiece movement, comprising:
a first escapement mobile element, pivotally mounted about a first axis of rotation, arranged to be engaged with a train of the timepiece movement, such as a motor train, to receive a motive force, and comprising a plurality of first blocking surfaces and a first drive toothing,
a second escapement mobile element, pivotally mounted about a second axis of rotation, comprising a plurality of second blocking surfaces and a second drive toothing,
an inertial element, pivotally mounted about a third axis of rotation, arranged to present oscillations each comprising a first vibration and a second vibration,
a blocking mobile element, pivotally mounted about a fourth axis of rotation, comprising:
   a first blocking surface portion, arranged to come into contact with one of the plurality of first blocking surfaces in order to block the rotation of the first escapement mobile element,
   a second blocking surface portion, arranged to come into contact with one of the plurality of second blocking surfaces in order to block the rotation of the second escapement mobile element,
   an impulse receiver, or impulse receiving means, arranged to receive a first impulse from the first escapement mobile element during a first vibration of an oscillation of the inertial element, and to receive a second impulse from the second escapement mobile element during a second vibration of said oscillation of the inertial element,
   an impulse transmitter, or impulse transmission means, arranged to transmit at least part of the first impulse or of the second impulse to the inertial element,
characterized in that:
the plurality of first blocking surfaces and the first drive toothing form a first main drive toothing,
the plurality of second blocking surfaces and the second drive toothing form a second main drive toothing,
in which the second main drive toothing is engaged with the first main drive toothing to transmit the motive force from the first escapement mobile element to the second escapement mobile element in a given plane,
and in which the first main drive toothing and the second main drive toothing are arranged to cooperate with the blocking mobile element in the same plane.

According to the implementation above, the escapement device comprises a single blocking mobile element and two escapement mobile elements. Unlike the escapement device of document WO2013182243A1 comprising two blocking mobile elements to be angularly indexed therebetween, no indexing is to be planned for the implementation above, because there is only one blocking mobile element. Moreover, a particularly compact assembly can be obtained because the blocking mobile element is pivotally mounted to alternately block the first or the second escapement mobile element: these can be mounted or arranged side by side, particularly symmetrically opposite a plane passing through the respective axes of rotation of the inertial element and of the blocking mobile element.

It can be noted that the escapement device according to the implementation above transmits two impulses to the inertial element during the same oscillation (one back-and-forth movement) of the inertial element, to sustain its oscillations. Indeed, the blocking mobile element can:
receive from the first escapement mobile element a first impulse and transmit it to the inertial element during a first vibration (for example a forward movement constituting a first half of an oscillation) of the inertial element, and
can receive from the second escapement mobile element a second impulse and transmit it to the inertial element during a second vibration (for example a return movement constituting a second half of the oscillation considered) of the inertial element.

According to this embodiment, the cooperation between the two escapement mobile elements takes place in the same plane as that of the cooperation of each escapement mobile element with the blocking mobile element, so that the total thickness of the escapement device is reduced and the pieces are easy to manufacture, because they can be designed planar and without relief.

The invention can be defined by the following characteristics, taken individually or in combination.

According to an embodiment, the inertial element comprises a balance. Particularly, the inertial element can comprise a balance, a balance-staff and a plate with a pin, coupled to a spiral spring.

According to an embodiment, the first blocking surface portion is arranged to block the rotation of the first escapement mobile element, that is to say an escapement movement of the first escapement mobile element, and/or the second blocking surface portion is arranged to block the rotation of the second escapement mobile element, that is to say an escapement movement of the second escapement mobile element.

According to an embodiment, the escapement device is free of stops or detent pins limiting the displacement of the blocking mobile element beyond a nominal blocking position.

According to an embodiment, the first blocking surface portion is arranged so that a first force, exerted on the blocking mobile element by the first escapement mobile element blocked by the first blocking surface portion, passes substantially in the vicinity of the fourth axis of rotation, particularly passes through the fourth axis of rotation, and in that the second blocking surface portion is arranged so that a second force, exerted on the blocking mobile element by the second escapement mobile element blocked by the second blocking surface portion, passes substantially in the vicinity of the fourth axis of rotation, particularly passes through the fourth axis of rotation.

According to an embodiment, the first force, exerted on the blocking mobile element by the first escapement mobile element blocked by the first blocking surface portion, passes substantially in the vicinity of the fourth axis of rotation, particularly passes through the fourth axis of rotation, so as to guarantee an absence of overturning torque (or banking torque) on the blocking mobile element during a rest phase. In other words, the first force, exerted on the blocking mobile element by the first escapement mobile element blocked by the first blocking surface portion, passes substantially in the vicinity of the fourth axis of rotation, particularly passes through the fourth axis of rotation, so as to guarantee a stable rest position of the blocking mobile element during a rest phase. In said rest phase, the blocking mobile element is only engaged with the first escapement mobile element.

According to an embodiment, the second force, exerted on the blocking mobile element by the second escapement mobile element blocked by the second blocking surface portion, passes substantially in the vicinity of the fourth axis of rotation, particularly passes through the fourth axis of rotation, so as to guarantee an absence of overturning torque (or banking torque) on the blocking mobile element during a rest phase. In other words, the second force, exerted on the blocking mobile element by the second escapement mobile element blocked by the second blocking surface portion, passes substantially in the vicinity of the fourth axis of rotation, particularly passes through the fourth axis of rotation, so as to guarantee a stable rest position of the blocking mobile element during a rest phase. In said rest phase, the blocking mobile element is only engaged with the second escapement mobile element.

According to an embodiment, the blocking mobile element is mounted in a free pivot connection. According to an embodiment, the blocking mobile element is mounted in a free pivot connection on a bridge and/or on a main plate of the timepiece. According to an embodiment, the blocking mobile element is free of an elastic return device, and/or the escapement device is free of an elastic return device coupled or engaged with the blocking mobile element to hold it or return it in a rest position (the fact remains that the elastic member (a sprung in a conventional manner) of the oscillator coupled to the inertial element causes, through the sustained movements of the inertial element, the unlocking of the escapement mobile elements and then the movements of the blocking mobile element). In other words, the displacements of the blocking mobile element are caused by the inertial element and/or the first escapement mobile element and/or the second escapement mobile element. Particularly, during the normal operation of the escapement device, the displacements of the blocking mobile element are exclusively caused by the inertial element and/or the first escapement mobile element and/or the second escapement mobile element.

According to an embodiment, the escapement device is not a direct-impulse escapement device. In other words, according to this embodiment, the first escapement mobile element and/or the second escapement mobile element do not cooperate directly with the inertial element (or a member of the oscillator typically formed by a sprung/balance pair).

It can be noted that the escapement device according to the implementation above provides increased operational safety, because the first or the second blocking force passes through the fourth axis of rotation: in the blocking position (or in the rest phase), the blocking mobile element does not undergo any overturning torque (or banking torque), which makes it possible to obtain a stable blocking position, and there is no need to provide for stops or detent pins normally necessary to limit the travel of the blocking mobile element, in particular in case of shock. Naturally, such an escapement device also adapts to the installation of stops or detent pins.

According to an embodiment, the first blocking surface portion is arranged so that a first friction cone constructed about a point of application of the force exerted by the first escapement mobile element on the blocking mobile element comprises, or encompasses, or passes through the fourth axis of rotation, and/or the second blocking surface portion is arranged so that a second friction cone constructed about a point of application of the force exerted by the second escapement mobile element on the blocking mobile element comprises, or encompasses, or passes through the fourth axis of rotation.

According to an embodiment, the first blocking surface portion has a first normal direction passing through the fourth axis of rotation or passing substantially through the fourth axis of rotation, and the second blocking surface portion has a second normal direction passing through the fourth axis of rotation or passing substantially through the fourth axis of rotation.

According to an embodiment:
a first straight line passing through the fourth axis of rotation and through a point of contact between the first escapement mobile element and the first blocking surface portion during a first blocking phase, and
a second straight line passing through the fourth axis of rotation and through a point of contact between the second escapement mobile element and the second blocking surface portion during a second blocking phase,
define an acute angle α therebetween. In other words, a triangle can be constructed, having:
as a first vertex, the fourth axis of rotation,
as a second vertex, the point of contact between the first escapement mobile element and the first blocking surface portion,
as a third vertex, the point of contact between the second escapement mobile element and the second blocking surface portion. According to the embodiment above, this triangle has an acute angle at its first vertex. Such a configuration makes it possible to guarantee a reduced travel for the blocking mobile element between a first blocking position (of the blocking mobile element) in which the first escapement mobile element is blocked (by the blocking mobile element) and a second blocking position (of the blocking mobile element) in which the second escapement mobile element is blocked (by the blocking mobile element). This provides a compact assembly.

According to an embodiment, the angle α is comprised in a range of values from 60° to 80°.

According to an embodiment:
the impulse receiver, or impulse receiving means, of the blocking mobile element comprise:
   a first impulse input portion, arranged to receive the first impulse from the first escapement mobile element during the first vibration of the balance,
   a second impulse input portion, arranged to receive the second impulse from the second escapement mobile element during the second vibration of the balance,
in which:
   the first impulse input portion is adjacent to the first blocking surface portion, and the second impulse input portion is adjacent to the second blocking surface portion,
and/or:
   the first impulse input portion is separated from the first blocking surface portion by a first rest beak, and the second impulse input portion is separated from the second blocking surface portion by a second rest beak.

According to an embodiment:
a third straight line passing through the fourth axis of rotation and through a point of contact between the first escapement mobile element and the first impulse input portion during a first impulse phase, and
a fourth straight line passing through the fourth axis of rotation and through a point of contact between the second escapement mobile element and the second impulse input portion during a second impulse phase,
define an acute angle γ therebetween.

According to an embodiment, the angle γ is comprised in a range of values from 50° to 70°.

According to an embodiment, the angle γ is smaller than the angle α.

According to an embodiment:
the first escapement mobile element comprises a plurality of first blocking teeth each comprising a first blocking surface of the plurality of first blocking surfaces, each first blocking tooth being arranged between two first drive teeth of the first drive toothing,
the second escapement mobile element comprises a plurality of second blocking teeth each comprising a second blocking surface of the plurality of second blocking surfaces, each second blocking tooth being arranged between two second drive teeth of the second drive toothing.

According to an embodiment:
each first blocking tooth comprises at least a first lateral drive surface, preferably with a circle involute profile, provided to mesh with a second drive tooth,
each second blocking tooth comprises at least a second lateral drive surface, preferably with a circle involute profile, provided to mesh with a first drive tooth.

According to an embodiment, the first blocking teeth and the second blocking teeth are asymmetrical.

According to an embodiment, the first blocking teeth and the second blocking teeth have a head diameter (DT2) greater than a head diameter (DT1) of the first and second drive teeth respectively.

According to an embodiment: 1.1.DT1≤DT2≤1.3.DT1.

According to an embodiment, the first blocking teeth and the second blocking teeth have a tooth thickness (e2) greater than a tooth thickness (e1) of the first and second drive teeth respectively.

According to an embodiment: 1.8.e1≤e2≤2.5.e1.

According to an embodiment, the first escapement mobile element and/or the second escapement mobile element comprises respectively between 3 and 8 first blocking teeth and between 3 and 8 second blocking teeth, and preferably 4 or 5 first blocking teeth and 4 or 5 second blocking teeth.

According to an embodiment:
the first escapement mobile element forms or comprises a first escapement wheel, and/or
the second escapement mobile element forms or comprises a second escapement wheel.

A second aspect of the invention can relate to an escapement device for a timepiece movement, comprising:
a first escapement mobile element, pivotally mounted about a first axis of rotation, arranged to be engaged with a train of the timepiece movement, such as a motor train, to receive a motive force, and comprising a plurality of first blocking surfaces and a first drive toothing,
a second escapement mobile element, pivotally mounted about a second axis of rotation, comprising a plurality of second blocking surfaces and a second drive toothing engaged with the first drive toothing to transmit the motive force of the first escapement mobile element to the second escapement mobile element,
an inertial element, pivotally mounted about a third axis of rotation, arranged to present oscillations each comprising a first vibration and a second vibration,
a blocking mobile element, pivotally mounted about a fourth axis of rotation, comprising:
   a first blocking surface portion, arranged to come into contact with one of the plurality of first blocking surfaces to block the rotation of the first escapement mobile element,
   a second blocking surface portion, arranged to come into contact with one of the plurality of second blocking surfaces to block the rotation of the second escapement mobile element,
   an impulse receiver, or impulse receiving means, arranged to receive a first impulse from the first escapement mobile element during a first vibration of an oscillation of the inertial element, and to receive a second impulse from the second escapement mobile element during a second vibration of said oscillation of the inertial element,
   an impulse transmitter, or impulse transmission means, arranged to transmit at least part of the first impulse or of the second impulse to the inertial element,
characterized in that the first blocking surface portion is arranged so that a first force, exerted on the blocking mobile element by the first escapement mobile element blocked by the first blocking surface portion, passes substantially in the vicinity of the fourth axis of rotation, particularly passes through the fourth axis of rotation, and in that the second blocking surface portion is arranged so that a second force, exerted on the blocking mobile element by the second escapement mobile element blocked by the second blocking surface portion, passes substantially in the vicinity of the fourth axis of rotation, particularly passes through the fourth axis of rotation.

According to the implementation above, the escapement device comprises a single blocking mobile element and two escapement mobile elements. Unlike the escapement device of document WO2013182243A1 comprising two blocking mobile elements to be angularly indexed therebetween, no indexing is to be planned for the implementation above, because there is only one blocking mobile element. Moreover, a particularly compact assembly can be obtained because the blocking mobile element is pivotally mounted to alternately block the first or the second escapement mobile element: these can be mounted or arranged side by side, particularly symmetrically opposite a plane passing through the respective axes of rotation of the inertial element and of the blocking mobile element. Finally, it can be noted that the escapement device according to the implementation above provides increased operational safety, because the first or the second blocking force passes through the fourth axis of rotation: in the blocking position (in rest phase), the blocking mobile element does not undergo any overturning torque (or banking torque), which makes it possible to obtain a stable blocking position, and there is no need to provide for stops or detent pins normally necessary to limit the travel of the blocking mobile element, in particular in case of shock.

It can be noted that the escapement device according to the implementation above transmits two impulses to the inertial element during a single oscillation (one back-and-forth movement) of the inertial element, to sustain its oscillations. Indeed, the blocking mobile element can:
receive from the first escapement mobile element a first impulse and transmit it (at least partly) to the inertial element during a first vibration (for example a forward movement constituting a first half of an oscillation) of the inertial element, and
receive from the second escapement mobile element a second impulse and transmit it (at least partly) to the inertial element during a second vibration (for example a return movement constituting a second half of the oscillation considered) of the inertial element.

The invention can be defined by the following characteristics, taken individually or in combination.

According to an embodiment, the inertial element comprises a balance. Particularly, the inertial element can comprise a balance, a balance-staff and a plate with a pin, coupled to a spiral spring.

According to an embodiment, the first blocking surface portion is arranged to block the rotation of the first escapement mobile element, that is to say an escapement movement of the first escapement mobile element, and/or the second blocking surface portion is arranged to block the rotation of the second escapement mobile element, that is to say an escapement movement of the second escapement mobile element.

According to an embodiment, the escapement device is free of stops or detent pins limiting the displacement of the blocking mobile element beyond a nominal blocking position.

According to an embodiment, the first blocking surface portion is arranged so that a first friction cone constructed about a point of application of the force exerted by the first escapement mobile element on the blocking mobile element comprises, or encompasses, or passes through the fourth axis of rotation, and/or the second blocking surface portion is arranged so that a second friction cone constructed about a point of application of the force exerted by the second escapement mobile element on the blocking mobile element comprises, or encompasses, or passes through the fourth axis of rotation.

According to an embodiment, the first blocking surface portion has a first normal direction passing through the fourth axis of rotation or passing substantially through the fourth axis of rotation, and the second blocking surface portion has a second normal direction passing by the fourth axis of rotation passing substantially through the fourth axis of rotation.

According to an embodiment:
a first straight line passing through the fourth axis of rotation and through a point of contact between the first escapement mobile element and the first blocking surface portion during a first blocking phase, and
a second straight line passing through the fourth axis of rotation and through a point of contact between the second escapement mobile element and the second blocking surface portion during a second blocking phase,
define an acute angle α therebetween. In other words, a triangle can be constructed, having:
as a first vertex, the fourth axis of rotation,
as a second vertex, the point of contact between the first escapement mobile element and the first blocking surface portion,
as a third vertex, the point of contact between the second escapement mobile element and the second blocking surface portion. According to the embodiment above, this triangle has an acute angle at its first vertex. Such a configuration makes it possible to guarantee a reduced travel for the blocking mobile element between a first blocking position (of the blocking mobile element) in which the first escapement mobile element is blocked (by the blocking mobile element) and a second blocking position (of the blocking mobile element) in which the second escapement mobile element is blocked (by the blocking mobile element). This provides a compact assembly.

In other words, the invention may concern an escapement device for a timepiece movement, comprising:
a first escapement mobile element, pivotally mounted about a first axis of rotation, arranged to be engaged with a train of the timepiece movement, such as a motor train, to receive a motive force, and comprising a plurality of first blocking surfaces and a first drive toothing,
a second escapement mobile element, pivotally mounted about a second axis of rotation, comprising a plurality of second blocking surfaces and a second drive toothing engaged with the first drive toothing,
an inertial element, such as a balance, pivotally mounted about a third axis of rotation, arranged to present oscillations each comprising a first vibration and a second vibration,
a blocking mobile element, pivotally mounted about a fourth axis of rotation, comprising:
   a first blocking surface portion, arranged to come into contact with one of the plurality of first blocking surfaces to block a movement of the first escapement mobile element,
   a second blocking surface portion, arranged to come into contact with one of the plurality of second blocking surfaces to block a movement of the second escapement mobile element,
   an impulse receiver, or impulse receiving means, arranged to receive a first impulse from the first escapement mobile element during a first vibration of an oscillation of the balance, and to receive a second impulse from the second escapement mobile element during a second vibration of said oscillation of the balance,
   an impulse transmitter, or impulse transmission means, arranged to transmit at least part of the first impulse or of the second impulse to the inertial element,
characterized in that:
a first straight line passing through a point of contact between the first escapement mobile element and the first blocking surface portion and a point through which the fourth axis of rotation passes, and
a second straight line passing through a point of contact between the second escapement mobile element and the second blocking surface portion and a point through which the fourth axis of rotation passes,
define an acute angle α therebetween.

According to an embodiment, the angle α is comprised in a range of values from 60° to 80°.

According to an embodiment, the plurality of first blocking surfaces and the plurality of second blocking surfaces are arranged to cooperate with the blocking mobile element in a first plane, called blocking plane, and the first drive toothing is arranged to cooperate with the second drive toothing in a second plane, called drive plane, parallel to and distinct from the blocking plane, to transmit the motive force from the first escapement mobile element to the second escapement mobile element. According to an embodiment, the first escapement mobile element and/or the second escapement mobile element can be formed by two superimposed components: a first level comprises the drive toothing and a second level comprises the blocking surfaces. The cooperation between the two escapement mobile elements takes place in a plane distinct from the cooperation of each escapement mobile element with the blocking mobile element.

According to an embodiment:
the plurality of first blocking surfaces and the first drive toothing form a first main drive toothing,
the plurality of second blocking surfaces and the second drive toothing form a second main drive toothing,
the second main drive toothing is engaged with the first main drive toothing to transmit the motive force from the first escapement mobile element to the second escapement mobile element in a given plane,
and the first main drive toothing and the second main drive toothing are arranged to cooperate with the blocking mobile element in the same plane. According to this embodiment, the cooperation between the two escapement mobile elements takes place in the same plane as that of the cooperation of each escapement mobile element with the blocking mobile element, so that the total thickness of the escapement device is reduced and the pieces are easy to manufacture, because they can be designed planar and without relief.

According to an embodiment:
the first escapement mobile element comprises a plurality of first blocking teeth each comprising a first blocking surface of the plurality of first blocking surfaces, the first blocking teeth being preferably asymmetrical,
the second escapement mobile element comprises a plurality of second blocking teeth each comprising a second blocking surface of the plurality of second blocking surfaces, the second blocking teeth being preferably asymmetrical,
and each of the first blocking teeth is arranged to cooperate with the second drive toothing and/or each of the second blocking teeth is arranged to cooperate with the first drive toothing to transmit the motive force from the first escapement mobile element to the second escapement mobile element.

According to an embodiment:
the first escapement mobile element comprises a plurality of first blocking teeth each comprising a first blocking surface of the plurality of first blocking surfaces,
the second escapement mobile element comprises a plurality of second blocking teeth each comprising a second blocking surface of the plurality of second blocking surfaces,
and the first blocking teeth and the second blocking teeth are asymmetrical.

According to an embodiment, the first escapement mobile element and/or the second escapement mobile element comprises respectively between 3 and 8 first blocking teeth and between 3 and 8 second blocking teeth, and preferably 4 or 5 first blocking teeth and 4 or 5 second blocking teeth.

According to an embodiment:
the impulse receiver, or impulse receiving means of the blocking mobile element comprise:
   a first impulse input portion, arranged to receive the first impulse from the first escapement mobile element during the first vibration of the balance,
   a second impulse input portion, arranged to receive the second impulse from the second escapement mobile element during the second vibration of the balance,
   and:
      the first impulse input portion is adjacent to the first blocking surface portion, and the second impulse input portion is adjacent to the second blocking surface portion,
      and or:
      the first impulse input portion is separated from the first blocking surface portion by a first rest beak, and the second impulse input portion is separated from the second blocking surface portion by a second rest beak.

According to an embodiment:
a third straight line passing through the fourth axis of rotation and through a point of contact between the first escapement mobile element and the first impulse input portion during a first impulse phase, and
a fourth straight line passing through the fourth axis of rotation and through a point of contact between the second escapement mobile element and the second impulse input portion during a second impulse phase,
define an acute angle γ therebetween.

According to an embodiment, the impulse receiver is provided or formed:
by a surface of the blocking mobile element, in particular by a lateral surface of the blocking mobile element,
by a component or part attached or embarked onto the blocking mobile element.

According to an embodiment, the impulse transmitter is provided or formed:
by a surface of the blocking mobile element, in particular by a lateral surface of the blocking mobile element,
by a component or part attached or embarked onto the blocking mobile element.

According to an embodiment, the angle γ is comprised in a range of values from 50° to 70°.

According to an embodiment, the angle γ is smaller than the angle α.

According to an embodiment:
the first blocking surface portion is concave, and/or
the second blocking surface portion is concave.

According to an embodiment:
the first blocking surface portion comprises at least two first secondary blocking surfaces forming a “V” or a “U”, preferably a V forming an obtuse angle βa, and preferably the angle βa is comprised in a range of values from 140° to 170°,
the second blocking surface portion comprises at least two second secondary blocking surfaces forming a “V” or a “U”, preferably a V forming an obtuse angle βb, and preferably the angle βb is comprised in a range of values from 140° to 170°.

According to an embodiment:
the first escapement mobile element forms or comprises a first escapement wheel, and/or
the second escapement mobile element forms or comprises a second escapement wheel.

A third aspect of the invention concerns a timepiece, comprising an escapement device according to the first or second aspect.

### DESCRIPTION OF THE FIGURES

Other characteristics and advantages of the present invention will appear more clearly upon reading the following detailed description of embodiments of the invention given by way of non-limiting examples and illustrated by the appended drawings, in which:

FIG. 1 represents a general view of an oscillator of a timepiece with an escapement device according to a first embodiment of the invention and comprising in particular a first escapement mobile element, a second escapement mobile element and a blocking mobile element;

FIG. 2 represents a view of the escapement device of FIG. 1, cooperating with a balance plate of the oscillator, during a rest phase;

FIG. 3 represents an enlarged view of the escapement device of FIG. 2, without the balance plate;

FIG. 4 represents a view of the blocking mobile element of the escapement device of FIGS. 1 to 3;

FIG. 5 represents a detail of the blocking mobile element of FIG. 4;

FIG. 6 represents a view of the second escapement mobile element of the escapement device of FIGS. 1 to 3;

FIG. 7 represents a view of the escapement device of FIG. 2, during the passage from a rest phase to an impulse phase;

FIG. 8 represents a view of the escapement device of FIG. 7, during an impulse phase

FIG. 9 represents an escapement device according to a second embodiment different from the escapement device of FIGS. 1 to 3 in some aspects, cooperating with a balance plate and comprising in particular a first escapement mobile element, a second escapement mobile element and a blocking mobile element;

FIG. 10 represents a view of the first escapement mobile element of the escapement device of FIG. 9;

FIG. 11 represents a view of the escapement device of FIG. 9, without the balance plate.

### DETAILED DESCRIPTION OF EMBODIMENT(S)

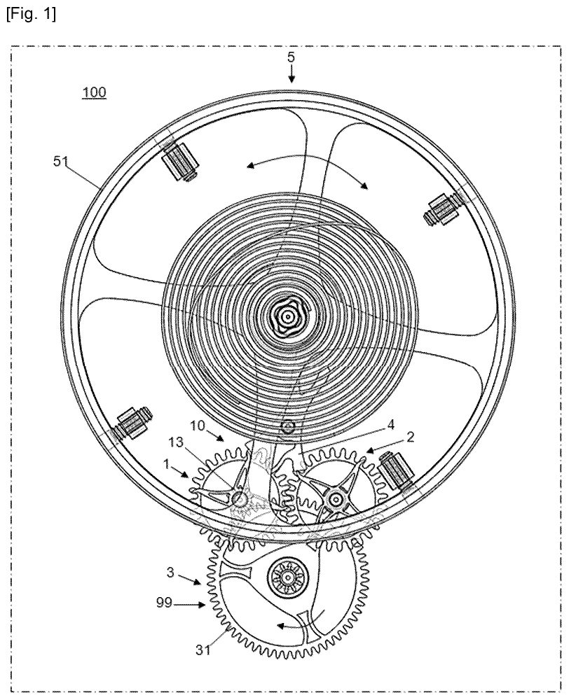

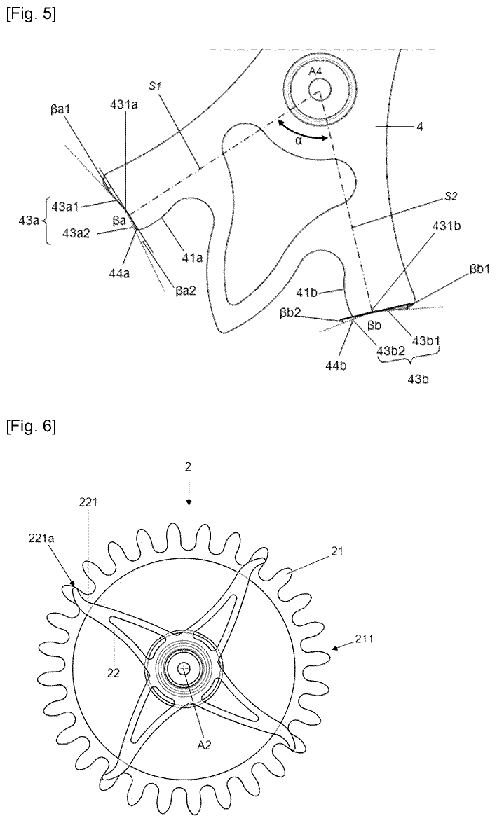

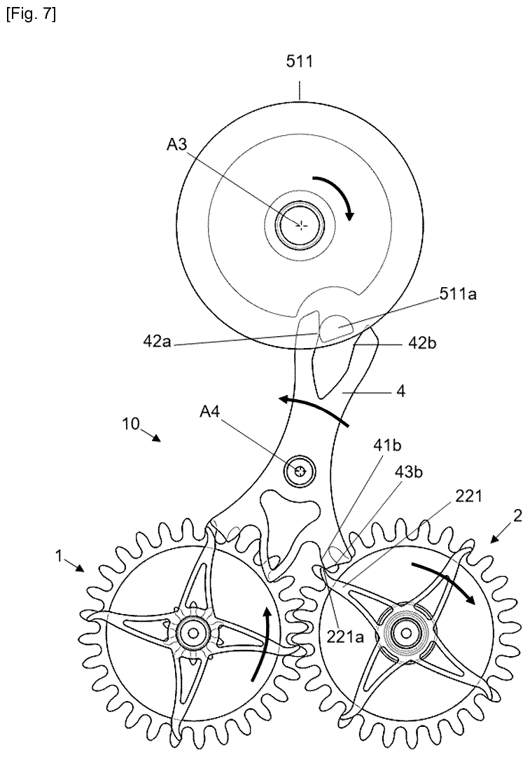

FIGS. 1 to 8 illustrate a tangential drive escapement device 10 with two active vibrations according to a first embodiment, namely that during the impulse phases of the escapement device, either of the first and second escapement mobile elements in contact with the blocking mobile element, and the blocking mobile element have rotations in opposite directions.

FIG. 1 represents an overview of a movement 100 comprising an escapement device 10 arranged between a train of the movement, here a motor train 99, and an oscillator 5 in the form of a balance 51 coupled to a spiral spring. The escapement device 10 comprises in particular:
a blocking mobile element 4,
a first escapement mobile element 1,
a second escapement mobile element 2.

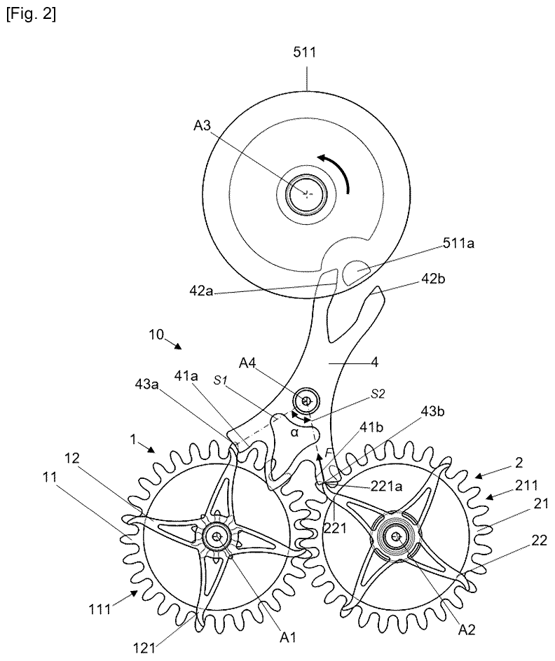

As will be explained below with reference to FIG. 2, the escapement device 10 cooperates with the resonator 5 via a pin embedded on a plate 511 of the balance 51. As for the motor train 99, FIG. 1 shows that the first escapement mobile element 1 is engaged with a motor wheel 3 of the motor train 99, particularly a wheel 31 of the motor train 99, via a pinion 13 secured to the first escapement mobile element 1.

As well known, the function of the escapement device 10 of the present invention is to sustain the oscillations of the regulating member, that is to say the balance 51 of the oscillator 5.

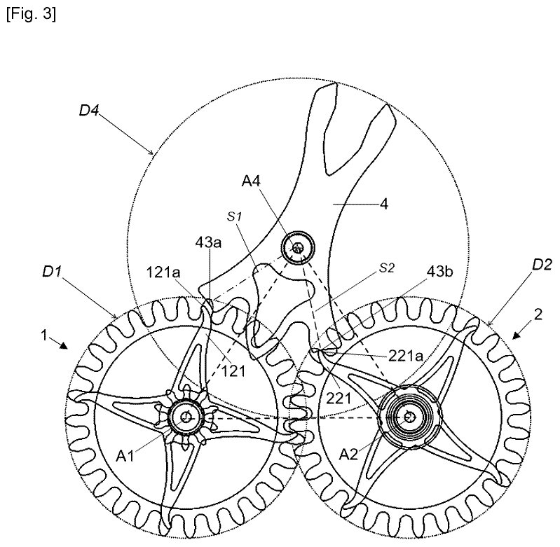

Particularly, as detailed in FIG. 2, the first escapement mobile element 1 is pivotally mounted about a first axis of rotation A1, and it is engaged with the motor train 99 of the timepiece movement to receive a motive force, and comprises a plurality of first blocking surfaces 121a arranged on first blocking teeth 121 (visible in FIGS. 2 and 3), as well as a first drive toothing 111. It can be noted that the first blocking teeth 121 and the first drive toothing 111 are arranged in parallel and distinct planes.

The second escapement mobile element 2 is pivotally mounted about a second axis of rotation A2, comprises a plurality of second blocking surfaces 221a arranged on second blocking teeth 221, as well as a second drive toothing 211 engaged with the first drive toothing 111. It can be noted that the second blocking teeth 221 and the second drive toothing 211 are provided in parallel and distinct planes.

The blocking mobile element 4 is pivotally mounted about a fourth axis of rotation A4, and comprises for its part an impulse receiver, or impulse receiving means, which is respectively in the form:
of a first impulse input portion 41a, arranged to receive a first impulse from the first escapement mobile element 1 during a first vibration of the balance 51,
of a second impulse input portion 41b, arranged to receive a second impulse from the second escapement mobile element 2 during a second vibration of the balance 51.

The blocking mobile element 4 also comprises an impulse transmitter, or impulse transmission means, with first and second impulse transmitter, or impulse transmission means, which are respectively in the form of a first impulse surface 42a and of a second impulse surface 42b, which form a fork such as the one known within a blocker or an anchor of an anchor escapement device. This fork is shaped to cooperate with a pin 511a of the plate 511 of the balance 51.

Finally, the blocking mobile element 4 comprises:
a first blocking surface portion 43a, arranged to come into contact with one of the plurality of first blocking surfaces 121a to block the rotation of the first escapement mobile element 1,
a second blocking surface portion 43b, arranged to come into contact with one of the plurality of second blocking surfaces 221a to block the rotation of the second escapement mobile element 2.

The first and second escapement mobile elements 1 and 2, comprising particularly first and second escapement wheels 12, 22 respectively, are provided to cooperate with the blocking wheel 4 so as to provide the impulses to the sprung-balance and thus allow sustaining its oscillations about a third axis of rotation A3, as will be described below. Moreover, the first and second escapement mobile elements 1, 2 mesh with each other via the first and second wheels 11, 21 respectively, particularly by means of the first and second drive toothing formed respectively by teeth 111, 211.

Advantageously, the motor mobile element 3 of FIG. 1 can be in direct engagement with a mobile element of the seconds (not represented) of the motor train 99. Indeed, such a construction makes it possible to generate rotational speeds of the first and second escapement mobile elements 1, 2 which make it possible to limit the number of teeth of the first and second escapement wheels 12, 22, and thus allow implementing the first and second escapement mobile elements 1, 2 whose respective dimensions are substantially of the same order as those of the blocking mobile element 4 to provide a compact escapement device with two active vibrations of dimensions substantially similar to those of a Swiss anchor escapement.

Particularly, the first and second escapement mobile elements 1 and 2 can be respectively inscribed in a cylinder of diameter D1, D2 each centered on the axis A1, A2 of the same order as the diameter D4 of the cylinder centered on the fourth axis of rotation A4 in which the blocking mobile element 4 can be inscribed (FIG. 3). In the specific construction illustrated in FIG. 3, the diameter D4 is greater than the diameter D1 or D2. Moreover, the axes A1, A2, A4 define the respective ends of a substantially equilateral triangle.

In one construction variant represented in FIGS. 1 to 8, D4 is equal to approximately 1.4.D1 or 1.4.D2 (D1 and D2 being identical). More generally, D4 is preferably comprised between D1 and 2.D1, or between D2 and 2.D2.

By “an element inscribed in a cylinder having a diameter D centered on an axis”, it is meant that the diameter D is the smallest diameter centered on the axis such that the element is included in the cylinder.

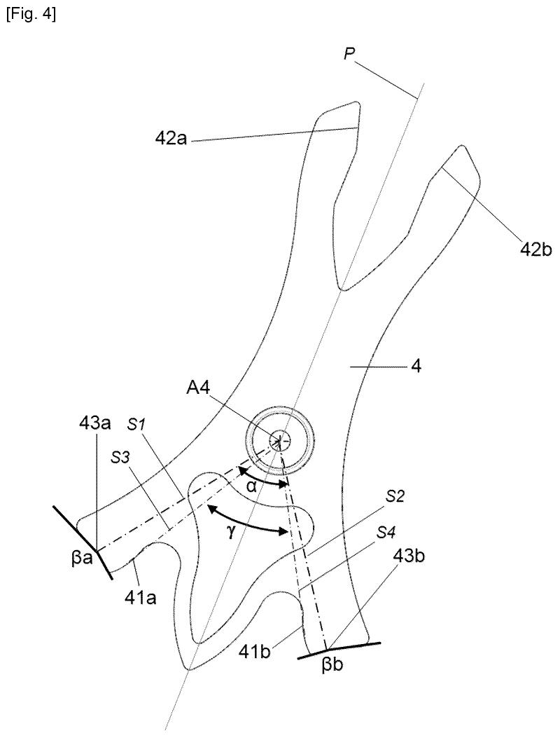

FIG. 4 represents a detailed top view of the blocking mobile element 4 in a plane. This highlights in particular an angle α separating a first straight line S1 connecting the first blocking surface portion 43a to the fourth axis of rotation A4 of a second straight line S2 connecting the second blocking surface portion 43b to the fourth axis of rotation A4. Particularly, the first straight line S1 connects the fourth axis of rotation A4 to the first blocking surface portion 43a at the level of the contact area, in particular at the level of the contact point 431a (see FIG. 5), between the first blocking surface portion 43a and a first blocking tooth 121, particularly an end 121a, during a rest phase of the escapement device 10. Particularly, the second straight line S2 connects the fourth axis of rotation A4 to the second blocking surface portion 43b at the level of the contact area, in particular at the level of the contact point 431b (see FIG. 5), between the second blocking surface portion 43b and a second blocking tooth 221, particularly an end 221a, during a rest phase of the escapement device (see FIG. 3).

In the construction variant represented here as an example, this angle α is approximately equal to 70°. More generally, the following range of values: 60°≤α≤80° can be provided.

Preferably and according to the exemplary embodiment represented, the first and second blocking surface portions 43a, 43b are concave, that is to say they are formed of continuous or discontinuous surfaces forming a V when they are seen from either of the escapement mobile elements. Thus, particularly, the points 431a, 431b are defined by the hollow tip of the “V” (FIG. 5).

These surfaces with continuous or discontinuous, rectilinear or curved portions, highlighted by bold lines in FIG. 4, form an angle βa, βb at the level of each of the surfaces 43a, 43b. If the first and second blocking surface portions 43a, 43b are curved, the angle βa, βb can be determined by considering tangents to said blocking surface portions. Advantageously, the angles βa, βb are obtuse angles. Preferably, the angles βa, βb are approximately equal to 170°. More generally, the angles βa, βb are preferably comprised between 140° and 175°. Studies conducted by the Applicant show that this angular range represents a good compromise between good blocking security, minimal or no rebound at the end of the impulse and the minimal energy loss upon unlocking. The angle βa may or may not be equal to the angle βb.

Moreover, these first and second blocking surface portions 43a, 43b are inclined with respect to the normal to the segments S1, S2 (FIG. 5). A first surface portion 43a1 can for example form an angle βa1 of the order of 6° with respect to the normal to the straight line S1. A second surface portion 43a2 can for example form an angle βa2 of the order of 8° with respect to the normal to the straight line S1. A first surface portion 43b1 can for example form an angle βb1 of the order of 6° with respect to the normal to the straight line S2. A second surface portion 43b2 can for example form an angle βb2 of the order of 8° with respect to the normal to the straight line S2. If the first and second blocking surface portions 43a, 43b are curved, the angles βa1, βa2, βb1, βb2 can be determined by considering tangents to said surface portions.

It can be noted in this FIG. 5 that the first and second blocking surface portions 43a, 43b are respectively adjacent to the first and second impulse input portions 41a, 41b. Indeed, the first blocking surface portion 43a joins the first impulse input portion 41a at the level of a first rest beak 44a which separates these two functional and adjacent surfaces. In the same way, the second blocking surface portion 43b joins the second impulse input portion 41b at the level of a second rest beak 44b which separates these two functional and adjacent surfaces.

During the rest phases of the escapement device, the ends 121a, 221a of the first and second blocking teeth 121, 221 are provided to be housed respectively within the first and second blocking surface portions 43a, 43b, more particularly within the “V” formed by the first and second blocking surface portions 43a, 43b. Advantageously, the ends 121a, 221a each have the form of a rounded surface.

By way of example, FIG. 2 represents a rest phase in which the end 221a of a second blocking tooth 221 is bearing against the second blocking surface portion 43b, more particularly within the “V” formed by this same second blocking surface portion. In this configuration, the pin 511a can free itself from the first impulse surface 42a under the effect of the rotation of the balance 51 along a first direction of rotation (represented by the arrow in FIG. 2), until this pin 511a regains contact with this same first impulse surface 42a under the effect of the rotation of the balance 51 along a second direction of rotation (represented by the arrow in FIG. 7) and thus allow the unlocking.

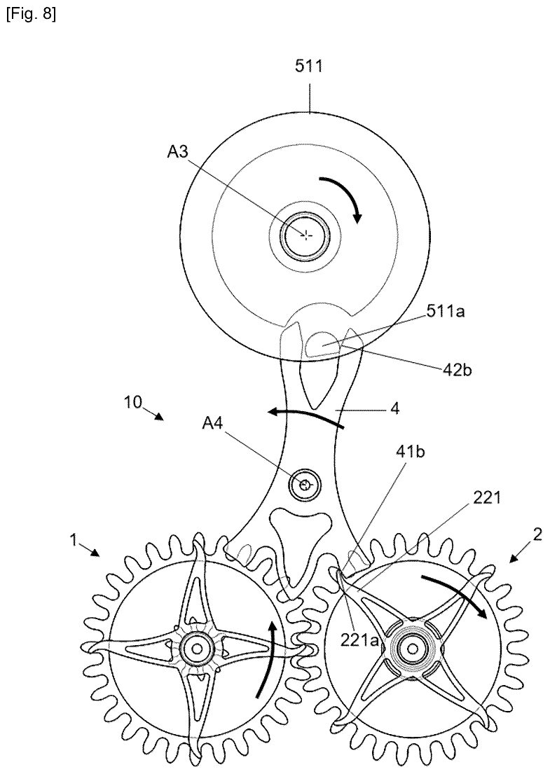

FIG. 7 illustrates an unlocking phase in which the end 221a of the second blocking tooth 221 has left the second blocking surface portion 43b under the effect of the pin 511a which leads the impulse surface 42a until the end 221a passes the second rest beak 44b and comes into contact with the second impulse input portion 41b, so that this end 221a can communicate an impulse to the blocking mobile element 4 via the second impulse input portion 41b, and that the blocking mobile element 4 can thus communicate an impulse to the pin 511a via the second impulse surface 42b, as represented in FIG. 8. This impulse phase continues to a following rest phase (not represented) in which one end 121a of a first blocking tooth 121 of the first escapement mobile element 1 comes into contact against the first blocking surface portion 43a of the blocking mobile element 4.

This second impulse input portion 41b is thus able to receive an impulse generated by the end 221a of the second blocking tooth 221 of the second escapement mobile element 2. The blocking mobile element 4 also comprises a first impulse input portion 41a able to receive an impulse generated by one end 121a of a first blocking tooth 121 of the first escapement mobile element 1. These first and second impulse input portions 41a, 41b are preferably convex when seen from either of the escapement mobile elements, as can be seen in the plan view of FIG. 5. Each of these first and second impulse input portions 41a, 41b in particular comprises a cylinder portion, particularly a cylinder portion whose directrix is a circle involute. These first and second impulse input portions 41a, 41b cooperate preferably with rounded surfaces 121a, 221a of the first and second blocking teeth 121, 221 having an asymmetrical profile. Such a conformation of blocking teeth makes it possible to optimize the geometries of the surfaces 121a, 221a and 41a, 41b with regard to the transmission of torque to the oscillator 5. Particularly, first and second asymmetrical blocking teeth 121, 221 allow generating a large choice of possible geometries for the first and second impulse input portions 41a, 41b.

As shown in FIG. 4, it is possible to construct an angle γ separating:
a third straight line S3, tangent to the first impulse input portion 41a and passing through the fourth axis of rotation A4,
a fourth straight line S4 tangent to the second impulse input portion 41b and passing through the fourth axis of rotation A4. Preferably, the angle γ is acute (see FIG. 4). Preferably, the first and second impulse input portions 41a, 41b fall within the angular range of angle α separating the surfaces 43a, 43b. Thus, the angle γ is strictly less than α. In one construction variant, the angle γ is approximately equal to 60°. More generally, the following range of values: 50°≤γ≤70° can be provided.

The blocking mobile element 4 can be symmetrical with respect to a plane P normal to the plane of the figure and passing through the fourth axis of rotation A4, particularly in the case where the surfaces 41a, 42a, 43a and 41b, 42b, 43b are identical. The manufacture is easier, and the piece can be mounted in one direction or another during the assembly. Naturally, the blocking mobile element 4 may not be symmetrical with respect to the plane P.

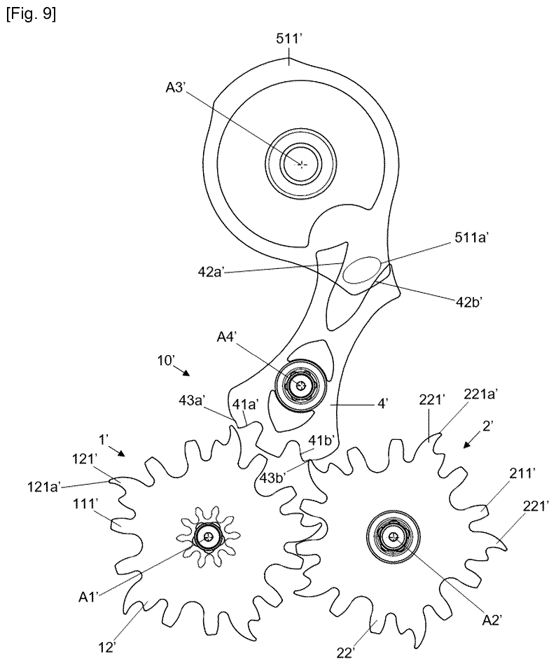

FIGS. 9 to 11 illustrate an escapement device 10′ according to a second embodiment. The operation of this second embodiment is in every respect identical to that of the escapement device according to the first embodiment, but the construction differs in some aspects described below, and the references are modified by the simple addition of an apostrophe: ′.

According to this second embodiment, the first escapement mobile element 1′ and the second escapement mobile element 2′ are each in the form of a planar component, here a single escapement wheel.

In detail, the first escapement mobile element 1′ is pivotally mounted about a first axis of rotation A1′, and it is arranged to be engaged with a motor train of the timepiece movement (not represented) to receive a motive force, and comprises a plurality of first blocking surfaces 121a′ provided on first blocking teeth 121′, as well as a first drive toothing 111′ together forming a first main drive toothing. As seen above, the first main drive toothing is essentially planar, that is to say the first blocking teeth 121′ and the first drive toothing 111′ are arranged in the same plane. It can finally be noted that the first blocking teeth 121′ have an asymmetrical profile, while the teeth of the first drive toothing 111′ have a symmetrical profile.

The second escapement mobile element 2′ is for its part pivotally mounted about a second axis of rotation A2′, and comprises a plurality of second blocking surfaces 221a′ provided on second blocking teeth 221′, as well as a second drive toothing 211′ together forming a second main drive toothing. As seen above, the second main drive toothing is essentially planar, that is to say the second blocking teeth 221′ and the second drive toothing 211′ are arranged in the same plane. It can finally be noted that the second blocking teeth 221′ have an asymmetrical profile, while the teeth of the second drive toothing 211′ have a symmetrical profile.

The first main drive toothing (comprising the first drive toothing 111′ and the first blocking teeth 121′) and the second main drive toothing (comprising the second drive toothing 211′ and the second blocking teeth 221′) cooperate on the one hand with each other and on the other hand with the blocking mobile element 4′ in the manner described below.

On the one hand, the first drive toothing 111′ and the second drive toothing 211′ are provided to be able to mesh together. The first drive toothing 111′ is also provided to be able to mesh with the second blocking teeth 221′, and the second drive toothing 211′ is also provided to be able to mesh with the first blocking teeth 121′. Thus, the first escapement mobile element 1′ and the second escapement mobile element 2′ have a synchronous movement.

On the other hand, the first blocking teeth 121′ and the second blocking teeth 221′, like the first and second blocking teeth 121, 221 of the first and second escapement mobile elements 1, 2 of the first embodiment, comprise an end respectively forming first and second blocking surfaces 121a′, 221a′ each in the form of a rounded surface provided to cooperate with the first and second blocking surface portions 43a′, 43b′ and with the impulse receiver, or impulse receiving means, of the blocking mobile element 4′.

Particularly, the following points can be noted:
the first drive toothing 111′ and the second drive toothing 211′ are exclusively intended to allow the meshing of the first and second escapement mobile elements 1′, 2′,
the first blocking teeth 121′ and the second blocking teeth 221′ are provided to cooperate with the blocking mobile element 4′, but also provided to allow the meshing of the first and second escapement mobile element wheels 1′, 2′. Particularly, the first blocking teeth 121′ are provided to cooperate successively with the first impulse input portion 41a′ and with the first blocking surface portion 43a′ of the blocking mobile element 4′. Likewise, the second blocking teeth 221′ are provided to cooperate successively with the first impulse input portion 41b′ and with the second blocking surface portion 43b′ of the blocking mobile element 4′.

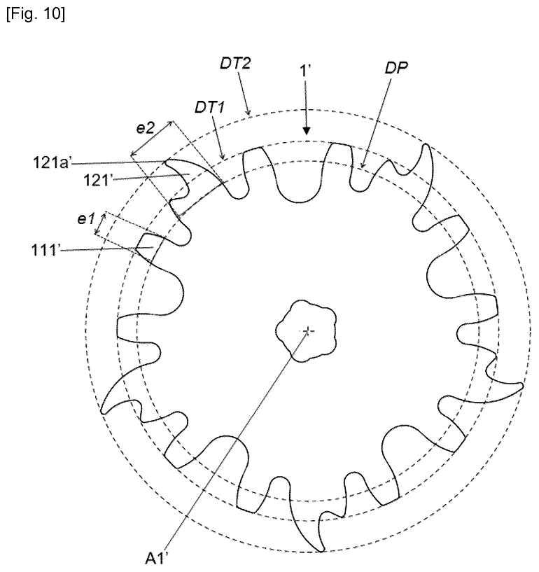

In this second embodiment, the head diameter DT2 of the first blocking teeth 121′ and of the second blocking teeth 221′ is greater than the diameter DT1 of the teeth of the first drive toothing 111′ and of the second drive toothing 211′, as shown in FIG. 10. In this way, the teeth of the first drive toothing 111′ and of the second drive toothing 211′ do not interact or interfere with the blocking mobile element 4′. In one particular construction variant, the diameter DT2 can be of the order of 1.2.DT1. More generally, the following range of values: 1.1.DT1≤DT2≤1.3.DT1 can be provided.

In this second embodiment, the thickness e2 of the first blocking teeth 121′ and of the second blocking teeth 221′ is advantageously different from the thickness e1 of the teeth of the first drive toothing 111′ and of the second drive toothing 211′. Preferably, the thickness e2 of the first blocking teeth 121′ and of the second blocking teeth 221′ is greater than the thickness e1 of the teeth of the first drive toothing 111′ and of the second drive toothing 211′ as also shown in FIG. 10. In one particular construction variant, the thickness e2 can be of the order of 1.9.e1. Preferably, the following range of values: 1.8.e1≤e2≤2.5.e1 can be provided.

By “thickness” it is meant the distance measured between two flanks of a given tooth, measured at the level of a diameter DP corresponding to or substantially coincident with the pitch diameter of the considered toothing.

In this way, the angular indexing of the first and second escapement mobile elements 1′, 2′ is carried out easily, without risk of error. Particularly, during the assembly, a given first blocking tooth 121′ can only be housed between two consecutive teeth of the second drive toothing 211′, and vice versa. The distribution of the teeth of the first and second main drive toothings about their respective axis means that only one angular indexing configuration is possible between the first and second escapement mobile elements 1′, 2′.

In this particular construction variant, the first and second escapement mobile elements 1′, 2′ each comprise:
ten teeth for the first drive toothing 111′ and ten teeth for the second drive toothing 211′ and
five first blocking teeth 121′ and five second blocking teeth 221′.

Particularly, two consecutive teeth of the first drive toothing 111′ and two consecutive teeth of the second drive toothing 211′ are disposed between two consecutive teeth of the first blocking teeth 121′ and of the second blocking teeth 221′, respectively.

Advantageously, the first and second escapement mobile elements 1′, 2′ are identical, the first and second escapement mobile elements 1′, 2′ can thus be respectively mounted in an inverted manner during the assembly of the escapement device 10′.

The escapement device according to the second embodiment is therefore particularly advantageous with regard to its compactness (an escapement mobile element being simply reduced to an escapement wheel), and to its simplicity of assembly (each escapement mobile element not resulting from an assembly, and the escapement mobile elements not needing to be assembled together with a keying system).

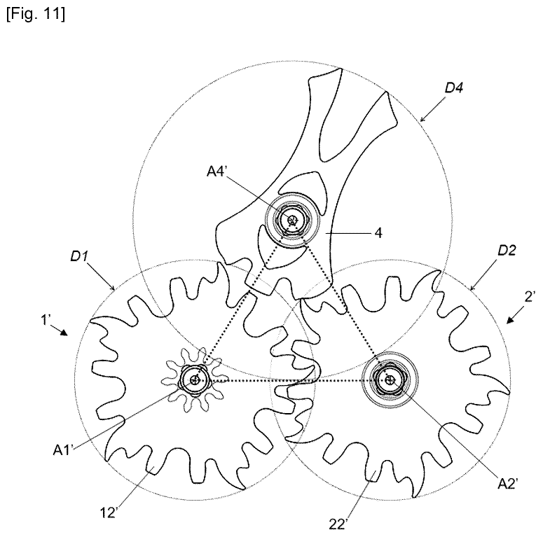

Concerning the dimensions in the plane of the elements of the escapement device 10′ according to the second embodiment, these are comparable to those of the elements of the device of the first embodiment (see FIGS. 3 and 11). Particularly, the diameter D4 is equal to approximately 1.3.D1 or 1.3.D2 (D1 and D2 being identical). More generally, D4 is preferably comprised between D1 and 2.D1, or between D2 and 2.D2.

### INDUSTRIAL APPLICATION

An escapement device according to the present invention, and its manufacture, are capable of industrial application.

It will be understood that various modifications and/or improvements obvious to those skilled in the art can be made to the different embodiments of the invention described in the present description without departing from the framework of the invention.

Particularly, it can be noted that whatever the embodiment, the blocking mobile element can be a one-piece component or result from an assembly. Particularly, the blocking means could for example be added onto the blocking mobile element, in the form of pallets which can be made of a particular material.

Preferably, the escapement mobile elements according to the first embodiment can form an assembly between a one-piece meshing wheel and a one-piece escapement wheel.

Preferably, the escapement mobile elements according to the second embodiment can each be in the form of a one-piece wheel.

Whatever the embodiment, the blocking mobile element and/or the escapement mobile element, particularly the escapement wheel, can comprise all or part of the monocrystalline silicon whatever its orientation, polycrystalline silicon, amorphous silicon, amorphous silicon dioxide, doped silicon whatever the type and level of doping, or porous silicon. It can also comprise silicon carbide, glass, ceramic, quartz, ruby or even sapphire. Alternatively, it can be manufactured from metal or metal alloy, in particular an at least partially amorphous metal alloy. For example, such a component may comprise Ni or NiP. Advantageously, an alloy such as the one described in patent application WO2017102661 can be used. It can also be provided to make all or part of these pieces from an amorphous metal alloy (it can for example be provided to form all or part of these pieces from metal glass).

Preferably, the escapement device is provided to cooperate with a sprung-balance, having a frequency of 3 or 4 Hz, or higher such as 5, 6, 8 or 10 Hz.

Naturally, it can be envisaged to take advantage of the escapement device to sustain the oscillations of any type of oscillator, whether it is a sprung-balance type oscillator as described previously or any other type of oscillator, for example an inertial element guided and elastically recalled by flexible blades.

1. An escapement device for a timepiece movement, comprising:
a first escapement mobile element, pivotally mounted about a first axis of rotation, arranged to be engaged with a train of the timepiece movement, such as a motor train, to receive a motive force, and comprising a plurality of first blocking surfaces and a first drive toothing,
a second escapement mobile element, pivotally mounted about a second axis of rotation, comprising a plurality of second blocking surfaces and a second drive toothing,
an inertial element, pivotally mounted about a third axis of rotation, arranged to present oscillations each comprising a first vibration and a second vibration,
a blocking mobile element, pivotally mounted about a fourth axis of rotation, comprising:
a first blocking surface portion, arranged to come into contact with one of the plurality of first blocking surfaces in order to block the rotation of the first escapement mobile element,
a second blocking surface portion, arranged to come into contact with one of the plurality of second blocking surfaces in order to block the rotation of the second escapement mobile element,
an impulse receiver, arranged to receive a first impulse from the first escapement mobile element during a first vibration of an oscillation of the inertial element, and to receive a second impulse from the second escapement mobile element during a second vibration of said oscillation of the inertial element,
an impulse transmitter, arranged to transmit at least part of the first impulse or of the second impulse to the inertial element,
characterized in that:
the plurality of first blocking surfaces and the first drive toothing form a first main drive toothing,
the plurality of second blocking surfaces and the second drive toothing form a second main drive toothing,
wherein the second main drive toothing is engaged with the first main drive toothing to transmit the motive force from the first escapement mobile element to the second escapement mobile element in a given plane,
and wherein the first main drive toothing and the second main drive toothing are arranged to cooperate with the blocking mobile element in the same plane.

2. The escapement device according to claim 1, wherein the first blocking surface portion is arranged so that a first force, exerted on the blocking mobile element by the first escapement mobile element blocked by the first blocking surface portion, passes substantially in the vicinity of the fourth axis of rotation, in particular passes through the fourth axis of rotation, and in that the second blocking surface portion is arranged so that a second force, exerted on the blocking mobile element by the second escapement mobile element blocked by the second blocking surface portion, passes substantially in the vicinity of the fourth axis of rotation, in particular passes through the fourth axis of rotation.

3. The escapement device according to claim 1, wherein:
a first straight line passing through the fourth axis of rotation and through a point of contact between the first escapement mobile element and the first blocking surface portion during a first blocking phase, and
a second straight line passing through the fourth axis of rotation and through a point of contact between the second escapement mobile element and the second blocking surface portion during a second blocking phase,
define an acute angle α therebetween.

4. The escapement device according to claim 3, wherein the angle α is comprised in a range of values from 60° to 80°.

5. The escapement device according to claim 1, wherein:
the impulse receiver of the blocking mobile element comprise:
a first impulse input portion, arranged to receive the first impulse from the first escapement mobile element during the first vibration of the balance,
a second impulse input portion, arranged to receive the second impulse from the second escapement mobile element during the second vibration of the balance,
wherein:
the first impulse input portion is adjacent to the first blocking surface portion, and the second impulse input portion is adjacent to the second blocking surface portion,
and/or:
the first impulse input portion is separated from the first blocking surface portion by a first rest beak, and the second impulse input portion is separated from the second blocking surface portion by a second rest beak.

6. The escapement device according to claim 5, wherein:
a third straight line passing through the fourth axis of rotation and through a point of contact between the first escapement mobile element and the first impulse input portion during a first impulse phase, and
a fourth straight line passing through the fourth axis of rotation and through a point of contact between the second escapement mobile element and the second impulse input portion during a second impulse phase,
define an acute angle γ therebetween.

7. The escapement device according to claim 6, wherein the angle γ is comprised in a range of values from 50° to 70°.

8. The escapement device according to claim 6, wherein the angle γ is smaller than the angle α.

9. The escapement device according to claim 1, wherein:
the first escapement mobile element comprises a plurality of first blocking teeth each comprising a first blocking surface of the plurality of first blocking surfaces, each first blocking tooth being arranged between two first drive teeth of the first drive toothing,
the second escapement mobile element comprises a plurality of second blocking teeth each comprising a second blocking surface of the plurality of second blocking surfaces, each second blocking tooth being arranged between two second drive teeth of the second drive toothing.

10. The escapement device according to claim 9, wherein:
each first blocking tooth comprises at least a first lateral drive surface, preferably with a circle involute profile, provided to mesh with a second drive tooth,
each second blocking tooth comprises at least a second lateral drive surface, preferably with a circle involute profile, provided to mesh with a first drive tooth.

11. The escapement device according to claim 9, wherein the first blocking teeth and the second blocking teeth are asymmetrical.

12. The escapement device according to claim 9, wherein the first blocking teeth and the second blocking teeth have a head diameter greater than a head diameter of the first and second drive teeth respectively, and preferably wherein:
1.1.DT1≤DT2≤1.3.DT1,
and/or wherein the first blocking teeth and the second blocking teeth have a tooth thickness (e2) greater than a tooth thickness (e1) of the first and second drive teeth respectively, and preferably wherein:
1.8.e1≤e2≤2.5.e1.

13. The escapement device according to claim 9, wherein the first escapement mobile element and/or the second escapement mobile element comprise respectively between 3 and 8 first blocking teeth and between 3 and 8 second blocking teeth, and preferably 4or 5 first blocking teeth and 4 or 5 second blocking teeth.

14. The escapement device according to claim 1, wherein:
the first escapement mobile element forms or comprises a first escapement wheel, and/or
the second escapement mobile element forms or comprises a second escapement wheel.

15. A timepiece, comprising an escapement device according to claim 1.
